(19) United States
(12) Patent Application Publication
(10) Pub. No.: US 2006/0202368 A1
(43) Pub. Date: Sep. 14, 2006

(54) Method for producing contact lenses

(76) Inventors: Yasuo Matsuzawa, Roswell, GA (US); Richard Charles Turek, Atlanta, GA (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/365,384

(22) Filed: Mar. 1, 2006

Related U.S. Application Data
(60) Provisional application No. 60/659,978, filed on Mar. 9, 2005.

(51) Int. Cl. B29D 11/00

(52) U.S. Cl. 264/1.32; 264/1.36

(57) ABSTRACT

The invention provides an improved process for manufacturing silicone-hydrogel contact lenses. The improvement includes use of a hot water in the step of dislodging (or removing or de-blocking) from a mold after lens being cured and before lens extraction. Hot water can be used efficiently to dislodge a hydrophobic silicone-hydrogel lens from its adhering mold half and to substantially reduce the stickiness (or tackiness) of the surfaces of the hydrophobic silicone-hydrogel lens.

This application claims the benefit under 35 USC 119(e) of the U.S. Provisional Patent Application No. 60/659,978 filed Mar. 9, 2005, herein incorporated by reference in its entirety.

The present invention is related to an improved method for producing contact lenses, in particular silicone hydrogel contact lenses.

### BACKGROUND OF THE INVENTION

In recent years, silicone hydrogel contact lenses, for example, Focus NIGHT & DAY™ and O₂OPTIX™ (both from CIBA VISION), have become more and more popular because of corneal health benefits provided by their high oxygen permeability and comfort.

Silicone hydrogel contact lenses can be manufactured economically in large numbers by a conventional full-mold process involving disposable molds, the examples of which are disclosed in, for example, PCT patent application Ser. No. WO/87/04390, in EP-A 0 367 513 or in U.S. Pat. No. 5,894,002. In a conventional molding process, a predetermined amount of a polymerizable or crosslinkable material typically is introduced into a disposable mold comprising a female (concave) mold half and a male (convex) mold half. The female and male mold halves cooperate with each other to form a mold cavity having a desired geometry for a contact lens. Normally, a surplus of polymerizable or crosslinkable material is used so that when the male and female halves of the mold are closed, the excess amount of the material is expelled out into an overflow area adjacent to the mold cavity. The polymerizable or crosslinkable material remaining within the mold is polymerized or cross-linked by means of actinic radiation (e.g., UV irradiation, ionized radiation, microwave irradiation) or by means of heating. The starting material in the mold cavity is cured to form a lens while the excess material in the overflow area is partially or completely cured to form flashes. After curing, the mold is separated into the male and female mold halves with the formed lens adhered onto either male or female mold half.

After mold separation, the lens on its respective mold half (male or female) together is subjected to extraction with an organic solvent (e.g., IPA (isopropyl alcohol)). This is done because the lens is difficult to be removed from the mold half due to a strong adhesion between the lens and the mold half. It is believed that this strong adhesion is due to the tackiness of the surface of a silicone hydrogel lens so produced. If the lens is removed from the mold half by force, the lens can adhere to itself (curl) and lens handling can be difficult and/or the lens can be damaged.

After the extraction, the lens, still on the mold half, is equilibrated in water and then removed from the mold half. However, the lens still adheres onto the mold surface, thus, a solvent mixture is used to deblock (or dislodge) the lens. The removed lens is further subjected to other process, such as, for example, plasma treatment, hydration, sterilization, etc.

In general, extraction and equilibration of lenses are carried out in batch processes. There are some disadvantages associated with each lens associated with one mold half. First, mold halves takes up valuable space in an extraction or equilibration tank and therefore reduce the capacity of extraction which can be carried out in each tank. Second, lens flashes can be partially or completely dissolve in an extraction bath. Any dissolution of lens flashes can potentially reduce extraction efficiency. Third, lens flashes may be still attached to the lens even after extraction and equilibration. Any lens with flashes attached thereto will be rejected and as such, production yield can be decreased. It would be desirable to have a step of removing, also known as “deblocking” or “dislodging”, the lens from the lens-adhering mold half.

An organic solvent, such as, e.g., isopropyl alcohol (IPA), can be used to dislodge a silicone-hydorgel lens from its adhering mold half. The solvent swells the lens and helps reduce the forces holding the lens to the mold half surface. However, once a lens is swollen, the large size of the lens makes it difficult to handle due to lack of mechanical strength. In addition, the lens after swelling in an organic solvent (e.g., IPA) may still be sticky or tacky.

PCT published international patent application No. WO 01/30558 describes a different approach for dislodging a lens from its adhering mold half, by lowering the temperature of the contact lens with a cryogenic material to a temperature and for a time sufficient for the lens to release from its adhering mold half without the application of external forces. The lowering of the temperature of the contact lens is accomplished by direct or indirect contact with a cryogenic substance, such as liquid nitrogen, liquid helium, liquid carbon dioxide, or solid carbon dioxide (“dry ice”). When a cryogenic substance is used to cool down a silicone hydrogel lens below its glass transition temperature (Tg), the surface tackiness temporarily freezes. This makes the lens separate from the mold half because of reduction in the tackiness and probably lens size reduction. However, the lens after separation becomes tacky again in air, which makes the lens handling difficult. In addition, use of a cryogenic substance can increases product cost.

Therefore, it would be beneficial to provide an improved process in which each lens is separated from its adhering mold half and/or lens flashes before extraction.

### SUMMARY OF THE INVENTION

In one aspect, the invention provide a method for producing contact lenses. The method comprises: providing a mold including a male mold half having a first molding surface and a female mold half having a second molding surface, wherein the male and female mold halves are configured to receive each other such that a mold cavity is formed between the first and second molding surfaces when the mold is closed; dispensing a specific amount of a silicone hydrogel lens-forming material into one of the male and female mold halves; mating the male and female mold halves to close the mold; curing the silicone hydrogel lens-forming material located between the two mold halves, thereby forming a molded silicone hydrogel contact lens having a hydrophobicity characterized by an average water contact angle of greater than about 100 degrees; separating the mold into the male and female mold halves, with the silicone hydrogel contact lens adhered on one of the male and female mold halves; dispensing a hot water over the lens and/or in the lens-adhering mold half; allowing the hot water to penetrate into interface between the lens and the lens-adhering mold half so as to reduce adhesion between the lens and the lens-adhering mold half; and removing the lens from the lens-adhering mold half and placing the lens in a tray for further processing.

In another aspect, the invention provide a method for producing contact lenses, comprising: providing a mold including a male mold half having a first molding surface and a female mold half having a second molding surface, wherein the male and female mold halves are configured to receive each other such that a mold cavity is formed between the first and second molding surfaces when the mold is closed; dispensing a specific amount of a silicone hydrogel lens-forming material into one of the male and female mold halves; mating the male and female mold halves to close the mold; curing the silicone hydrogel lens-forming material located between the two mold halves, thereby forming a molded silicone hydrogel contact lens having a hydrophobicity characterized by an average water contact angle of greater than about 100 degrees; separating the mold into the male and female mold halves, with the silicone hydrogel contact lens adhered on one of the male and female mold halves; placing the lens and its adhering mold half in a well; dispensing a hot water in the well in an amount sufficient to submerge at least the lens and a mold half portion with the lens adhered thereon; allowing the hot water to penetrate into interface between the lens and the lens-adhering mold half so as to dislodge the lens from the lens-adhering mold half; and transferring the lens from the well to a tray for further processing.

The present invention provides the foregoing and other features, and the advantages of the invention will become further apparent from the following detailed description of the presently preferred embodiments, read in conjunction with the accompanying figures. The detailed description and figures are merely illustrative of the invention and do not limit the scope of the invention, which is defined by the appended claims and equivalents thereof.

### DESCRIPTION OF PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term.

A “hydrogel” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers.

A “silicone hydrogel” refers to a hydrogel obtained by copolymerization of a polymerizable composition comprising at least one silicone-containing monomer or at least one silicone-containing macromer.

A “monomer” means a low molecular weight compound that comprises one or more crosslinkable groups and can be crosslinked and/or polymerized actinically or thermally or chemically to obtain a crosslinked and/or polymerized polymer. Low molecular weight typically means average molecular weights less than 700 Daltons.

A “vinylic monomer”, as used herein, refers to a low molecular weight compound that has an ethylenically unsaturated group and can be polymerized actinically or thermally. Low molecular weight typically means average molecular weights less than 700 Daltons.

The term “olefinically unsaturated group” is employed herein in a broad sense and is intended to encompass any groups containing at least one>C=C<group. Exemplary ethylenically unsaturated groups include without limitation acryloyl, methacryloyl, allyl, vinyl, styrenyl, or other C=C containing groups.

As used herein, “actinically” in reference to curing or polymerizing of a polymerizable composition or material means that the curing (e.g., crosslinked and/or polymerized) is performed by actinic irradiation, such as, for example, UV irradiation, ionized radiation (e.g. gamma ray or X-ray irradiation), microwave irradiation, and the like. Thermal curing or actinic curing methods are well-known to a person skilled in the art.

A “hydrophilic vinylic monomer”, as used herein, refers to a vinylic monomer which as a homopolymer typically yields a polymer that is water-soluble or can absorb at least 10 percent by weight water.

A “hydrophobic vinylic monomer”, as used herein, refers to a vinylic monomer which as a homopolymer typically yields a polymer that is insoluble in water and can absorb less than 10 percent by weight water.

A “macromer” refers to a medium and high molecular weight compound or polymer that contains functional groups capable of undergoing further polymerizing/crosslinking reactions. Medium and high molecular weight typically means average molecular weights greater than 700 Daltons. Preferably, a macromer contains ethylenically unsaturated groups and can be polymerized actinically or thermally.

A “polymer” means a material formed by polymerizing/crosslinking one or more monomers, macromers and or oligomers.

“Molecular weight” of a polymeric material (including monomeric or macromeric materials), as used herein, refers to the number-average molecular weight unless otherwise specifically noted or unless testing conditions indicate otherwise.

A “prepolymer” refers to a starting polymer which can be cured (e.g., crosslinked and/or polymerized) actinically or thermally or chemically to obtain a crosslinked and/or polymerized polymer having a molecular weight much higher than the starting polymer. A “actinically crosslinkable prepolymer” refers to a starting polymer which can be crosslinked upon actinic radiation to obtain a crosslinked polymer having a molecular weight much higher than the starting polymer.

A “lens-forming material” refers to a polymerizable composition which can be cured (i.e., polymerized and/or crosslinked) thermally or actinically or chemically to obtain a crosslinked polymer. Lens-forming materials are well known to a person skilled in the art. In accordance with the invention, a lens-forming material comprises at least one silicon-containing monomer or macromer, or can be any lens formulations for making soft contact lenses. Exemplary lens formulations include without limitation the formulations of lotrafilcon A, lotrafilcon B, etafilcon A, genfilcon A, lenefilcon A, polymacon, acquafilcon A, balafilcon, senofilcon A, and the like. A lens-forming material can further include other components, such as an initiator (e.g., a photoinitiator or a thermal initiator), a visibility tinting agent, UV-blocking agent, photosensitizers, and the like. Preferably, a silicone hydrogel lens-forming material used in the present invention comprises a silicone-containing macromer.

Examples of silicone-containing monomers include, without limitation, methacryloxyalkylsiloxanes, 3-methacryloxy propylpentamethyidisiloxane, bis(methacryloxypropyl)tetramethyl-disiloxane, monomethacrylated polydimethylsiloxane, mercapto-terminated polydimethylsiloxane, N-[tris(trimethylsiloxy)silylpropyl]acrylamide, N-[tris(trimethylsiloxy)silylpropyl]methacrylamide, tris(pentamethyldisiloxyanyl)-3-methacrylatopropylsilane (T2), and tristrimethylsilyloxysilylpropyl methacrylate (TRIS). A preferred siloxane-containing monomer is TRIS, which is referred to 3-methacryloxypropyltris(trimethylsiloxy) silane, and represented by CAS No. 17096-07-0. The term “TRIS” also includes dimers of 3-methacryloxypropyltris(trimethylsiloxy) silane.

Any know suitable silicone-containing macromer can be used to prepare soft contact lenses. A particularly preferred siloxane-containing macromer is selected from the group consisting of Macromer A, Macromer B, Macromer C, and Macromer D described in U.S. Pat. No. 5,760,100, herein incorporated by reference in its entirety.

An “average water contact angle” refers to a contact angle (Sessile Drop) of water on a contact lens, which is obtained by averaging measurements with at least 3 individual contact lenses. “Hydrophilic,” as used herein, describes a material or portion thereof that will more readily associate with water than with lipids.

The term “hydrophobicity” in reference to a contact lens is intended to describe the poor surface wettability by water of a contact lens. The poor surface wettability by water of a contact lens is characterized to have an average water contact angle of greater than 100 degrees.

The “oxygen transmissibility” of a lens, as used herein, is the rate at which oxygen will pass through a specific ophthalmic lens. Oxygen transmissibility, Dk/t, is conventionally expressed in units of barrers/mm, where t is the average thickness of the material [in units of mm] over the area being measured and “barrer/mm” is defined as:
[(cm³ oxygen)/(cm²)(sec)(mm² Hg)]×10⁻⁹

The intrinsic “oxygen permeability”, Dk, of a lens material does not depend on lens thickness. Intrinsic oxygen permeability is the rate at which oxygen will pass through a material. Oxygen permeability is conventionally expressed in units of barrers, where “barrer” is defined as:
[(cm³ oxygen)(mm)/(cm²)(sec)(mm² Hg)]×10^{31 10}
These are the units commonly used in the art. Thus, in order to be consistent with the use in the art, the unit “barrer” will have the meanings as defined above. For example, a lens having a Dk of 90 barrers (“oxygen permeability barrers”) and a thickness of 90 microns (0.090 mm) would have a Dk/t of 100 barrers/mm (oxygen transmissibility barrers/mm). In accordance with the invention, a high oxygen permeability in reference to a material or a contact lens characterized by apparent oxygen permeability of at least 40 barrers or larger measured with a sample (film or lens) of 100 microns in thickness according to a coulometric method described in Examples.

The invention is generally related to a method for dislodging (or removing or de-blocking) from a mold after lens curing and before lens extraction and/or hydration. The invention is partly based on the discovery that hot water can be used efficiently to dislodge a hydrophobic silicone-hydrogel lens from its adhering mold half and to substantially reduce the stickiness (or tackiness) of the surfaces of the hydrophobic silicone-hydrogel lens.

Although the inventors do not wish to be bound by any particular theory, it is believed that the strong adhesion between a hydrophobic silicone hydrogel lens and a mold half and the tackiness of the surfaces of the lens are mainly due to uncured monomeric and oligomeric components at the interface between the cured lens-forming material and the mold surface. The uncured components are significant present at the interface because of the oxygen involvement during the polymerization at the interface. The uncured monomers or macromers or oligomers become adhesive at the interface, resulting in difficulty in dislodging the lens from the mold surface.

It is further believed that hot water substantially free of surfactant may play the following several roles in dislodging a lens from a mold half and in reducing the tackiness of the surfaces of the lens. First, hot water can replace a portion of an organic solvent present in a molded silicone-hydrogel lens by exchange, because a lens-forming material for mold-casting of silicon-hydrogel lenses generally contains an organic solvent. Replacement of an organic solvent by water can decrease the swelling of the molded lens and make the molded lens smaller in diameter, allowing the molded lens disengage from the mold surface. Second, The uncured polymerizable components (such as, e.g., monomers, macromers, and/or oligomers) located at the interface between a molded lens and a mold half can be dissolved in hot water. Dissolution of the uncured polymerizable components can reduce substantially the tackiness of the surfaces of a molded lens and facilitate the handling of the lens after dislodging from the mold half. Third, because of relatively high temperature, hot water can induce the contraction of thermally reversible silicone-hydrogel network while simultaneously cause the expansion of a lens-adhering mold half. As such, a silicone-hydrogel lens can be easily dislodged from the lens-adhering mold half.

There are several advantages associated with a method of the invention. First, application of hot water enables a molded lens to be dislodged from its adhering mold half without tearing the lens. Second, lens dislodging by hot water is a relatively fast process, for example, taking several seconds. Third, hot water can facilitate removal of a silicone-hydrogel lens from its adhering mold half while not removing flashes. Without flashes being attached to a lens, lens production yield can be increased. By dissolving flashes prior to extraction, extraction efficiency can be enhanced. Without mold halves, an extraction tank can accommodate much more lenses and product cost associated with extraction equipments can be decreased.

In one aspect, the invention provide a method for producing contact lenses. The method comprises: providing a mold including a male mold half having a first molding surface and a female mold half having a second molding surface, wherein the male and female mold halves are configured to receive each other such that a mold cavity is formed between the first and second molding surfaces when the mold is closed; dispensing a specific amount of a silicone hydrogel lens-forming material into one of the male and female mold halves; mating the male and female mold halves to close the mold; curing the silicone hydrogel lens-forming material located between the two mold halves, thereby forming a molded silicone hydrogel contact lens having a hydrophobicity characterized by an average water contact angle of greater than about 100 degrees; separating the mold into the male and female mold halves, with the silicone hydrogel contact lens adhered on one of the male and female mold halves; dispensing a hot water over the lens and/or in the lens-adhering mold half; allowing the hot water to penetrate into interface between the lens and the lens-adhering mold half so as to reduce adhesion between the lens and the lens-adhering mold half; and removing the lens from the lens-adhering mold half and placing the lens in a tray for further processing.

In accordance with the invention, a silicone-hydrogel contact lens preferably has a high oxygen permeability characterized by an apparent oxygen permeability of at least about 40 barrers, preferably at least about 60 barrers, more preferably at least about 80 barrers, measured with a sample (film or lens) of 100 microns in thickness according to a coulometric method.

In accordance with the invention, hot water used to dislodge a silicone-hydrogel lens from a mold preferably is substantially free of surfactant. As used herein, the term “substantially free of surfactant” means that the concentration of one or more surfactants in hot water is less than 0.005% by weight, preferably less than 0.0001% by weight, more preferably less than 0.00001% by weight, even more preferably free of surfactant.

Methods of manufacturing mold sections for cast-molding a contact lens are generally well known to those of ordinary skill in the art. The process of the present invention is not limited to any particular method of forming a mold. In fact, any method of forming a mold can be used in the present invention. However, for illustrative purposes, the following discussion has been provided as one embodiment of forming a mold.

In general, a mold comprises at least two mold sections (or portions) or mold halves, i.e. male and female mold halves. The male mold half defines a first molding (or optical) surface defining the posterior (concave) surface of a lens and the second mold half defines a second molding (or optical) surface defining the anterior (convex) surface of a lens. The first and second mold halves are configured to receive each other such that a lens forming cavity is formed between the first molding surface and the second molding surface. The molding surface of a mold half is the cavity-forming surface of the mold and in direct contact with lens-forming material.

The first and second mold halves can be formed through various techniques, such as injection molding. These half sections can later be joined together such that a cavity forms therebetween. Thereafter, a contact lens can be formed within the cavity of the mold sections using various processing techniques, such as actinic or thermal curing. Examples of suitable processes for forming the mold halves are disclosed in U.S. Pat. Nos. 4,444,711 to Schad; 4,460,534 to Boehm et al.; 5,843,346 to Morrill; and 5,894,002 to Boneberger et al., which are also incorporated herein by reference.

Virtually all materials known in the art for making molds can be used to make molds for making contact lenses. For example, polymeric materials, such as polyethylene, polypropylene, and PMMA can be used. Other materials that allow UV light transmission could be used, such as quartz glass.

Preferably, one of the female and male mold halves is subjected to a surface treatment, such as, for example, a corona treatment or a plasma treatment or the like, prior to its use in order for the molded contact lens to adhere preferentially to one particular mold half when opening the mold. Such pre-treatment is described in U.S. Pat. No. 5,894,002, herein incorporated by reference in its entirety.

A specific amount of a polymerizable lens-forming material is typically dispensed into a female mold half by means of a dispensing device and then a male mold half is put on and the mold is closed. As the mold closes, any excess unpolymerized lens-forming material is pressed into an overflow provided on the female mold half (or alternatively on the male mold half).

Subsequently, the closed mold containing the polymerizable lens-forming material is cured. A person skilled in the art knows well how to cure a lens-forming material. For example, a lens-forming material is subjected to actinic irradiation (e.g., UV radiation) at least in the region of the lens forming cavity or thermal treatment (e.g., heating in an oven) to form a lens. For actinic curing, at least one of the mold halves is transparent to the actinic radiation (e.g., UV light) at least in the region of the molding surface. Thus, at least the polymerizable lens-forming material in the lens forming cavity is polymerized. It is also possible for any polymerizable lens-forming material in the overflow to be polymerized. This is advantageous in the respect that, when the mold is opened, the excess polymerized lens-forming material then remains in the overflow of the female mold half, while the contact lens adhering to the male mold half can be removed and further processed together with male mold half.

Subsequently, the mold is opened, preferably by an apparatus described in a copending patent application entitled “Method for producing contact lenses” filed on Mar. 20, 2005 (herein incorporated by reference in its entirety). A mold is separated into a male mold half and a female mold half, with the molded lens adhered to one of the two mold halves.

A hot water is intended to describe a water having a temperature of higher than about 60° C., preferably higher than about 70° C., more preferably higher than about 80° C., even more preferably from about 90° C. to about 100° C.

In accordance with the invention, a hot water is dispensed over the lens and/or in the lens-adhering mold half and then is allowed to penetrate into interface between the lens and the lens-adhering mold half so as to reduce adhesion between the lens and the lens-adhering mold half. A period of time of at least about 5 seconds, preferably at least about 15 second, more preferably at least about 30 seconds, even more preferably at least about 1 minute is allowed to let hot water to penetrate into interface between the lens and the lens-adhering mold half.

In a preferred embodiment, the molded lens is adhered to the female mold half. The hot water is dispensed in an amount sufficient to submerge the molded lens adhered on the female mold half.

After dispensing hot water and allowing the hot water to penetrate into the interface between the lens and the lens-adhering mold half, the lens can be removed, for example, by a pair of tweezers the tips of which are covered with silicone rubber or a lens removing device known to a person skilled in the art.

In accordance with the invention, after dislodging from the mold half, the lens is placed in a tray for further processing, such as, for example, extraction, hydration, etc. As used herein, a tray is intended to describe a device which can hold a plurality of contact lenses and used in lens processing, such as, for example, extraction, hydration, equilibration. Any trays or equivalents can be used in the invention. Preferred trays are those described in a copending U.S. patent application Ser. No. 10/152,930 filed May 22, 2002 (here incorporated by reference in its entirety).

Typically, polymerization of monomers is not very efficient; so that there remains a significant fraction of monomers after the “cure” is complete. Most of the time, these monomers could represent a serious health issue, so unpolymerized monomers are required to be extracted (i.e., removed) in an appropriate solvent extraction process from the formed contact lenses. The extraction solvent can be water for a hydrophilic contact lens or a water-miscible organic solvent or a mixture of water and water-miscible organic solvent for a hydrophobic silicone-hydrogel contact lens. After extraction, contact lenses typically require undergoing a hydration process in which an organic solvent used in extraction (if applicable) will be replaced by water or an aqueous solution.

In another aspect, the invention provide a method for producing contact lenses, comprising: providing a mold including a male mold half having a first molding surface and a female mold half having a second molding surface, wherein the male and female mold halves are configured to receive each other such that a mold cavity is formed between the first and second molding surfaces when the mold is closed; dispensing a specific amount of a silicone hydrogel lens-forming material into one of the male and female mold halves; mating the male and female mold halves to close the mold; curing the silicone hydrogel lens-forming material located between the two mold halves, thereby forming a molded silicone hydrogel contact lens having a hydrophobicity characterized by an average water contact angle of greater than about 100 degrees; separating the mold into the male and female mold halves, with the silicone hydrogel contact lens adhered on one of the male and female mold halves; placing the lens and its adhering mold half in a well; dispensing a hot water in the well in an amount sufficient to submerge at least the lens and a mold half portion with the lens adhered thereon; allowing the hot water to penetrate into interface between the lens and the lens-adhering mold half so as to dislodge the lens from the lens-adhering mold half; and transferring the lens from the well to a tray for further processing.

The molded lens is adhered either on the male mold half or on the female mold half. With pre-treatment of molds, one can ensure that a molded contact lens is preferentially adhered to one particular mold half, the male mold half or the female mold half, when opening the mold.

In a preferred embodiment, the molded lens is adhered to the male mold half. The hot water is dispensed in an amount sufficient to submerge the molded lens adhered on the male mold half.

Preferably, a mold half portion with the lens adhered thereon is dipped into the well, namely, the molding surface of a mold half is facing the bottom of the well when placing the lens and its adhering mold half in the well.

It is understood that a method of the invention can be performed manually or automatically under control of a computer. A person skilled in the art known how to automate a method of the invention.

It is also understood that a silicone-hydrogel lens so produced can further subject other lens manufacturing processes, such as for example, surface treatment, sterilization, and the like. “Surface modification”, as used herein, means that an article has been treated in a surface treatment process (or a surface modification process), in which, by means of contact with a vapor or liquid, and/or by means of application of an energy source (1) a coating is applied to the surface of an article, (2) chemical species are adsorbed onto the surface of an article, (3) the chemical nature (e.g., electrostatic charge) of chemical groups on the surface of an article are altered, or (4) the surface properties of an article are otherwise modified. Exemplary surface treatment processes include, but are not limited to, a surface treatment by energy (e.g., a plasma, a static electrical charge, irradiation, or other energy source), chemical treatments, the grafting of hydrophilic monomers or macromers onto the surface of an article, and layer-by-layer (LbL) deposition of polyelectrolytes. A preferred class of surface treatment processes are plasma processes, in which an ionized gas is applied to the surface of an article, and LbL coating processes.

Plasma gases and processing conditions are described more fully in U.S. Pat. Nos. 4,312,575 and 4,632,844 and published U.S. patent application Ser. No. 2002/0025389, which are incorporated herein by reference. The plasma gas is preferably a mixture of lower alkanes and nitrogen, oxygen or an inert gas.

“LbL coating”, as used herein, refers to a coating that is not covalently attached to an article, preferably a medical device, and is obtained through a layer-by-layer (“LbL”) deposition of polyionic (or charged) and/or non-charged materials on an article. An LbL coating can be composed of one or more layers, preferably one or more bilayers.

The term “bilayer” is employed herein in a broad sense and is intended to encompass: a coating structure formed on a medical device by alternatively applying, in no particular order, one layer of a first polyionic material (or charged material) and subsequently one layer of a second polyionic material (or charged material) having charges opposite of the charges of the first polyionic material (or the charged material); or a coating structure formed on a medical device by alternatively applying, in no particular order, one layer of a first charged polymeric material and one layer of a non-charged polymeric material or a second charged polymeric material. It should be understood that the layers of the first and second coating materials (described above) may be intertwined with each other in the bilayer.

Formation of an LbL coating on an ophthalmic device may be accomplished in a number of ways, for example, as described in U.S. Pat. No. 6,451,871 (herein incorporated by reference in its entirety) and U.S. patent application publication Nos. 2001-0045676 A1, 2001-0048975 A1, and 2004-0067365 A1 (herein incorporated by reference in their entireties). One coating process embodiment involves solely dip-coating and dip-rinsing steps. Another coating process embodiment involves solely spray-coating and spray-rinsing steps. However, a number of alternatives involve various combinations of spray- and dip-coating and rinsing steps may be designed by a person having ordinary skill in the art.

The previous disclosure will enable one having ordinary skill in the art to practice the invention. In order to better enable the reader to understand specific embodiments and the advantages thereof, reference to the following examples is suggested. The percentages in the formulations are based on weight percentages unless otherwise specified.

### EXAMPLE 1

Unless otherwise stated, all chemicals are used as received.

Synthesis of Macromer

51.5 g (50 mmol) of the perfluoropolyether Fomblin® ZDOL (from Ausimont S.p.A, Milan) having a mean molecular weight of 1030 g/mol and containing 1.96 meq/g of hydroxyl groups according to end-group titration is introduced into a three-neck flask together with 50 mg of dibutyltin dilaurate. The flask contents are evacuated to about 20 mbar with stirring and subsequently decompressed with argon. This operation is repeated twice. 22.2 g (0.1 mol) of freshly distilled isophorone diisocyanate kept under argon are subsequently added in a counterstream of argon. The temperature in the flask is kept below 30° C. by cooling with a waterbath. After stirring overnight at room temperature, the reaction is complete. Isocyanate titration gives an NCO content of 1.40 meq/g (theory: 1.35 meq/g).

202 g of the α,ω-hydroxypropyl-terminated polydimethylsiloxane KF-6001 from Shin-Etsu having a mean molecular weight of 2000 g/mol (1.00 meq/g of hydroxyl groups according to titration) are introduced into a flask. The flask contents are evacuated to approx. 0.1 mbar and decompressed with argon. This operation is repeated twice. The degassed siloxane is dissolved in 202 ml of freshly distilled toluene kept under argon, and 100 mg of dibutyltin dilaurate (DBTDL) are added. After complete homogenization of the solution, all the perfluoropolyether reacted with isophorone diisocyanate (IPDI) is added under argon. After stirring overnight at room temperature, the reaction is complete. The solvent is stripped off under a high vacuum at room temperature. Microtitration shows 0.36 meq/g of hydroxyl groups (theory 0.37 meq/g).

13.78 g (88.9 mmol) of 2-isocyanatoethyl methacrylate (IEM) are added under argon to 247 g of the α,σ-hydroxypropyl-terminated polysiloxane-perfluoropolyether-polysiloxane three-block copolymer (a three-block copolymer on stoichiometric average, but other block lengths are also present). The mixture is stirred at room temperature for three days. Microtitration then no longer shows any isocyanate groups (detection limit 0.01 meq/g). 0.34 meq/g of methacryl groups are found (theory 0.34 meq/g).

The macromer prepared in this way is completely colourless and clear. It can be stored in air at room temperature for several months in the absence of light without any change in molecular weight.

Lens-Forming Material (Lens Formulation)

The above prepared siloxane-containing macromer is use in a lens-forming material comprising 37.4% Macromer, 15.0% TRIS, 22.5% DMA, 0.3% Darocure® 1173, and 24.8% Ethanol for prepare lotrafilcon A lenses. All percentages are by weight.

### EXAMPLE 2

Lens Production

The lens formulation prepared in Example 1 is degassed to remove oxygen from the lens formulation. An amount of the degassed lens formulation is introduced into each polypropylene molds in a nitrogen glove box and cured under UV light to form contact lenses. After curing, each mold is separated into a male mold half and a female mold half, with a molded lens adhered to one of the male and female mold halves, by use of an apparatus described in a copending patent application entitled “Method for producing contact lenses” filed on Mar. 20, 2005 (herein incorporated by reference in its entirety). Separated male and female mold halves are placed on different trays.

Where a lens is adhered to a female mold half, a hot water (about 95° C. to about 100° C.) is dispensed in each female mold half with a lens. Where a lens is adhered to a male mold half, a hot water (about 95° C. to about 100° C.) is dispensed in an empty female half and a male mold half with a lens adhered thereon is placed in the female mold half containing the hot water (with the molding surface of the male mold half facing down).

After dispensing the hot water, a minimum of one minute is allowed to let water penetrate into the interface between the lens and the mold half. Slide or move the lens in the mold half using a pair of tweezers with tips covered with silicone rubber. Place the lens on an extraction (or extraction and drying tray). Then, lenses are extracted in IPA. After extraction, the lenses are dried and then subjected plasma treatment according to procedures described in published U.S. patent application Ser. No. 2002/0025389 to obtain plasma coatings. Lenses with plasma coatings are subjected to hydration and packaged in a lens container containing a packaging solution (e.g., a buffered saline). Packaged lenses are sterilized.

Two different water dispensing methods are tested.

In a first series of experiments, hot water is dispensed using an electrical hot water dispenser (Zojirushi, Japan). The temperature of hot water is controlled at about 95° C. About 0.75 ml of hot water is dispensed in each female mold half with a lens thereon. About 1 to about 5 minutes are allowed to let water penetrate into the interface between the lens and the mold half.

In a second series of experiments, dispensing of hot water is carried out manually by transferring about 0.75 ml of hot water (about 100° C.) from a beaker (maintained at 100° C.) into a female mold half with a lens adhered thereon. About 1 minute is allowed to let water penetrate into the interface between the lens and the mold half.

It is observed that the lens edge is separated from the critical edge during hot water application. At 100° C. trial (the second series of experiments), separation of lenses from the mold surface occurs in a short period of time (e.g., about several seconds) and all lenses are completely separated from the mold surface in the process time specified in the experiments. There are a couple of lenses, which needed a move by tweezers in order to separate the lens from the mold surface. However, in the first series of experiments done at 95° C., a longer process time is needed to free all lenses the mold surface without tweezers.

The weights of lenses, which are separated machenically and by hot water-assisted deblocking, are compared with each other. It is found that they are about the same weight.

### EXAMPLE 3

Water Contact Angle Measurements

The water contact angle generally measures the surface hydrophilicity of a contact lens. In particular, a low water contact angle corresponds to more hydrophilic surface. A water contact angle of greater than 100 degrees on a surface indicates that the surface is hydrophobic. Average water contact angles (Sessile Drop) of contact lenses are measured using a VCA 2500 XE contact angle measurement device from AST, Inc., located in Boston, Mass. The averaged water contact angle of a contact lens, which is made of lotrafilcon A and prepared according to the procedures described in Example 2 without any surface treatment (e.g., plasma coating), is about 112 degrees.

Water contact angles on lenses, which are separated mechanically and by hot water-assisted deblocking, are compared with each other. Water contact angle on lenses which are separated mechanically is about 91 degrees (averaged over measurements with 8 lenses) whereas water contact angle on lenses which are separated by hot water-assisted deblocking is about 107 degrees (averaged value over measurements of 8 lenses). These results may indicate that uncured components of the lens formulation may be washed off by hot water from the surface of a lens.

Oxygen Permeability Measurements

The oxygen permeability of a lens and oxygen transmissibility of a lens material is determined according to a technique similar to the one described in U.S. Pat. No. 5,760,100 and in an article by Winterton et al., (The Cornea: Transactions of the World Congress on the Cornea 111, H. D. Cavanagh Ed., Raven Press: New York 1988, pp273-280), both of which are herein incorporated by reference in their entireties. Oxygen fluxes (J) are measured at 34° C. in a wet cell (i.e., gas streams are maintained at about 100% relative humidity) using a Dk1000 instrument (available from Applied Design and Development Co., Norcross, Ga.), or similar analytical instrument. An air stream, having a known percentage of oxygen (e.g., 3%-21%), is passed across one side of the lens at a rate of about 10 to 20 cm³/min., while a nitrogen stream is passed on the opposite side of the lens at a rate of about 10 to 20 cm³/min. A sample is equilibrated in a test media (i.e., saline or distilled water) at the prescribed test temperature for at least 30 minutes prior to measurement but not more than 45 minutes. Any test media used as the overlayer is equilibrated at the prescribed test temperature for at least 30 minutes prior to measurement but not more than 45 minutes. The stir motor's speed is set to 1200±50 rpm, corresponding to an indicated setting of 400±15 on the stepper motor controller. The barometric pressure surrounding the system, P_{measured}, is measured. The thickness (t) of the lens in the area being exposed for testing is determined by measuring about 10 locations with a Mitotoya micrometer VL-50, or similar instrument, and averaging the measurements. The oxygen concentration in the nitrogen stream (i.e., oxygen which diffuses through the lens) is measured using the DK1000 instrument. The apparent oxygen permeability of the lens material, Dkₐₚₚ, is determined from the following formula:
Dkₐₚₚ=Jt/(P_{oxygen})
   where J=oxygen flux [microliters O₂/cm²−minute]
   P_{oxygen}=(P_{measured}−P_{water} vapor)=(%O₂ in air stream) [mm Hg]=partial pressure of oxygen in the air stream
   P_{measured}=barometric pressure (mm Hg)
   P_{water} vapor=0 mm Hg at 34° C. (in a dry cell) (mm Hg)
   P_{water} vapor=40 mm Hg at 34 C. (in a wet cell) (mm Hg)
   t=average thickness of the lens over the exposed test area (mm)

where Dkₐₚₚ is expressed in units of barrers.

The oxygen transmissibility (Dk/t) of the material may be calculated by dividing the oxygen permeability (Dkₐₚₚ) by the average thickness (t) of the lens.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part. Therefore, the spirit and scope of the appended claims should not be limited to the description of the preferred versions contained therein.

What is claimed is:

1. A method for producing contact lenses, comprising the steps of:
a) providing a mold including a male mold half having a first molding surface and a female mold half having a second molding surface, wherein the male and female mold halves are configured to receive each other such that a mold cavity is formed between the first and second molding surfaces when the mold is closed;
b) dispensing a specific amount of a silicone hydrogel lens-forming material into one of the male and female mold halves;
c) mating the male and female mold halves to close the mold;
d) curing the silicone hydrogel lens-forming material located between the two mold halves, thereby forming a molded silicone hydrogel contact lens;
e) separating the mold into the male and female mold halves, with the silicone hydrogel contact lens adhered on one of the male and female mold halves, wherein the silicone hydrogel contact lens is hydrophobic and characterized by an average water contact angle of greater than about 100 degrees;
f) dispensing a hot water over the lens and/or in the lens-adhering mold half;
g) allowing the hot water to penetrate into interface between the lens and the lens-adhering mold half so as to reduce adhesion between the lens and the lens-adhering mold half; and
h) removing the lens from the lens-adhering mold half for further processing.

2. The method of claim 1, wherein one of the female and male mold halves is subjected to a surface treatment prior to its use in order for the molded contact lens to adhere preferentially to one particular mold half when opening the mold.

3. The method of claim 2, wherein the surface treatment is a corona treatment or a plasma treatment.

4. The method of claim 2, wherein the female mold half is subjected to the surface treatment.

5. The method of claim 2, wherein the male mold half is subjected to the surface treatment.

6. The method of claim 1, wherein the hot water has a temperature of higher than about 80° C.

7. The method of claim 6, wherein the hot water has a temperature of from about 90° C. to about 100° C.

8. The method of claim 1, wherein the molded lens is adhered to the female mold half.

9. The method of claim 8, wherein the hot water is dispensed in the female mold half in an amount sufficient to submerge the molded lens adhered on the female mold half.

10. The method of claim 9, wherein in step g) at least about 5 seconds is allowed to let the hot water penetrate into interface between the lens and the lens-adhering mold half.

11. A method for producing contact lenses, comprising the steps of:
a) providing a mold including a male mold half having a first molding surface and a female mold half having a second molding surface, wherein the male and female mold halves are configured to receive each other such that a mold cavity is formed between the first and second molding surfaces when the mold is closed;
b) dispensing a specific amount of a silicone hydrogel lens-forming material into one of the male and female mold halves;
c) mating the male and female mold halves to close the mold;
d) curing the silicone hydrogel lens-forming material located between the two mold halves, thereby forming a molded silicone hydrogel contact lens, wherein the silicone hydrogel contact lens is hydrophobic and characterized by an average water contact angle of greater than about 100 degrees;
e) separating the mold into the male and female mold halves, with the silicone hydrogel contact lens adhered on one of the male and female mold halves;
f) placing the lens and its adhering mold half in a well;
g) dispensing a hot water in the well in an amount sufficient to submerge at least the lens and a mold half portion with the lens adhered thereon;
h) allowing the hot water to penetrate into interface between the lens and the lens-adhering mold half so as to dislodge the lens from the lens-adhering mold half; and
i) transferring the lens from the well to a tray or a container for further processing

12. The method of claim 11, wherein one of the female and male mold halves is subjected to a surface treatment prior to its use in order for the molded contact lens to adhere preferentially to one particular mold half when opening the mold.

13. The method of claim 12, wherein the surface treatment is a corona treatment or a plasma treatment.

14. The method of claim 12, wherein the female mold half is subjected to the surface treatment.

15. The method of claim 12, wherein the male mold half is subjected to the surface treatment.

16. The method of claim 11, wherein the hot water has a temperature of higher than about 80° C.

17. The method of claim 16, wherein the hot water has a temperature of from about 90° C. to about 100° C.

18. The method of claim 11, wherein the molded lens is adhered to the male mold half.

19. The method of claim 18, wherein the hot water is dispensed in the well in an amount sufficient to submerge the molded lens adhered on the male mold half.

20. The method of claim 19, wherein in step h) at least about 5 seconds is allowed to let the hot water penetrate into interface between the lens and the lens-adhering mold half.
